(19) United States
(12) Patent Application Publication
(10) Pub. No.: US 2006/0221037 A1
(43) Pub. Date: Oct. 5, 2006

(54) System for driving inertia-prone picture-reproducing devices

(75) Inventors: Torsten Solf, Aachen (DE); Kai Eck, Aachen (DE); Martin Weibrecht, Aachen (DE)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V., Eindhoven (NL)

(21) Appl. No.: 10/568,554

(22) PCT Filed: Aug. 16, 2004
(86) PCT No.: PCT/IB04/51463

§ 371 Date: Feb. 17, 2006

(30) Foreign Application Priority Data
Aug. 22, 2003 (EP) 03102630.5

(51) Int. Cl. G09G 3/36

(52) U.S. Cl. 345/98

(57) ABSTRACT

In a system for driving inertia-prone picture-reproducing devices, in particular liquid-crystal displays, in which a correcting value that depends on changes in the video signals from frame to frame is added to incoming video signals to compensate for the inertial effects and in which the corrected video signals are passed to the picture-reproducing device to form the correcting value, a model of the picture-reproducing device is provided that has a state variable as an output variable, the video signals as a first input variable and the state variable from a preceding frame as a second input variable. Furthermore, to derive the correcting value, a function having the incoming video signals and the state variable of the preceding variable as input variables and the corrected video signals as an output variable.

The invention relates to a system for driving inertia-prone picture-reproducing devices, in particular liquid crystal displays, in which a correcting value depending on changes in the video signals from frame to frame is added to incoming video signals to compensate for the inertial effects, and in which the corrected video signals are passed to the picture-reproducing device.

Liquid crystal displays (LCDs) are known for an unsatisfactory transient response. A sudden change in an incoming video signal between two consecutive frames does not result in a corresponding sudden change in the luminance delivered by the LCD. Instead of this, the liquid-crystal display exhibits a notable inertia, the delivered luminance only gradually approaching the predefined value. The transition may extend over a plurality of frame periods (refresh cycles). This behavior results, in particular, in motion disturbances in moving frame sequences, in which edges, in particular, are reproduced in blurred form. The motion disturbance depends on the amplitude of the respective current video signal and on the preceding video signals. In addition, the luminance response of the liquid-crystal display depends on the respective technology specifically used.

Because of the fuzzy edges of moving objects in frame sequences, this effect is also referred to below as motion blur. In a method disclosed, for example, by U.S. Pat. No. 6,304,254 B1, the respective preceding frame is stored. The values of the individual pixels of the current frame and of the preceding frame are entered in a table from which a correcting value is read out that results in an overdrive of a sudden change in the video signal. A motion blur can indeed be improved thereby to a first approximation. However, the know method has various disadvantages. Thus, for example, an overdrive beyond the limits of the amplitude range of the amplifier of the liquid-crystal display is not possible. If, however, an adequate overdrive is absent as a result, a later correction can then also no longer be made after such a sudden change because of the storage of only one frame.

US 2002/0175907 A1 discloses a system comprising a liquid-crystal display in which a prediction of the capacitance values of the elements of the liquid-crystal display is used to form correcting values. This utilizes the fact that the liquid crystals, which do not adjust themselves to the particular situation in an infinitely short time, slowly change the capacitance of the individual elements, as a result of which the applied voltage also changes. In this known system, the capacitance values are stored as a function of the applied voltage and consequently serve indirectly as a measure of the overdrive to be applied.

With the system according to the invention, the motion blur is improved

in that, to form the correcting value, a model of the picture-reproducing device is provided that has a state variable as an output variable, the video signals as a first input variable and the state variable from a preceding frame as a second input variable, and

in that, furthermore, to derive the correcting value, a function having the incoming video signals and the state variable of the preceding frame as input variables and the corrected video signals as an output variable. The function is preferably stored in a table.

The state variable is, in this case, the numerical representation of a variable derived from the variation with time of the luminance that is produced by the sudden signal changes. Said variable may be, for example, the luminance at the end of a frame period or the luminance averaged over a frame period.

Compared with the abovementioned known method, the system according to the invention has the advantage that no systematic errors are introduced by the improved overdrive if the correction cannot be performed in a single step (from frame to frame). Instead of this, in the case of the invention, only a limited dynamic range is needed and an optimum correction is possible over more than one frame. In addition, the correction can easily be distributed over a plurality of frames, even if a single-stage correction were possible in principle.

This flexibility is advantageous for various reasons. The use of a time model of the liquid-crystal display in order to determine the overdrive is naturally limited in regard to precision. If an attempt is made to perform the correction from one frame to the next, this can easily result in an overcompensation in moving edges. In the system according to the invention, however, an adjustment can definitely be made in which the correction extends over a plurality of frames so that any overcompensation can be eliminated.

Finally, the inertial behavior of liquid-crystal displays is strongly asymmetrical, which means that the behavior at rising edges differs substantially from that at falling edges of the video signals. This may result in a situation in which only one of two opposite edges of a moving object can be corrected in one step, that is to say from one frame to the next, while the opposite edge requires a correction over a plurality of frames. In the edge method, asymmetrical disturbances consequently occur, while as many frames as necessary may enter into the correction in the method according to the invention.

Compared with the abovementioned known system, the system according to the invention has the advantage that the luminance response to the particular video signal is largely completely taken into account. The luminance response can be metrologically determined in advance for a type, for a charge or a specimen of the liquid-crystal display.

An advantageous embodiment of the invention is that the corrected video signals are the first input variable of the model. Since, however, the correcting value is known in each case, provision can also be made in another advantageous embodiment that the incoming video signals are the first input variable and that the model includes a derivation of the correcting value. This embodiment can be simplified in such a way that the model and the table for deriving the correcting value are combined in a common table.

Finally, provision can also be made in a further embodiment that the common table contains an addition of the incoming video signals and the correcting value.

In order to make the store for the tables or the model, respectively, as small as possible and consequently keep it inexpensive, provision may furthermore be made in the system according to the invention that interpolation nodes of the input and output variables are stored in the model and that means are provided for interpolation between the interpolation nodes.

These are other aspects of the invention are apparent from and will be elucidated with reference to the embodiments described hereinafter. In the drawings:

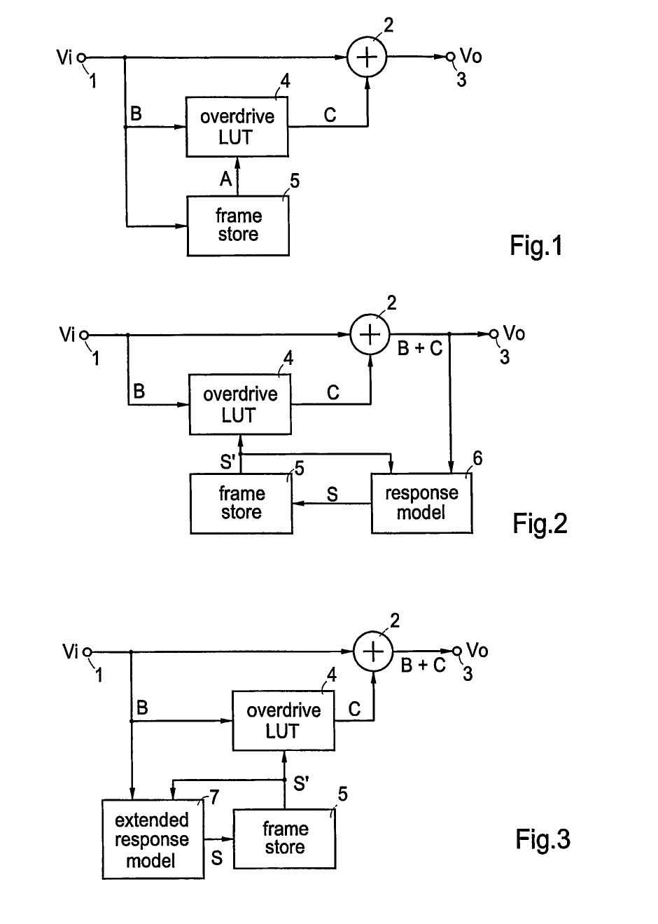

FIG. 1 shows a block circuit diagram of a system for performing the known method,

FIG. 2 shows a block circuit diagram of a first exemplary embodiment,

FIG. 3 shows a block circuit diagram of a second exemplary embodiment,

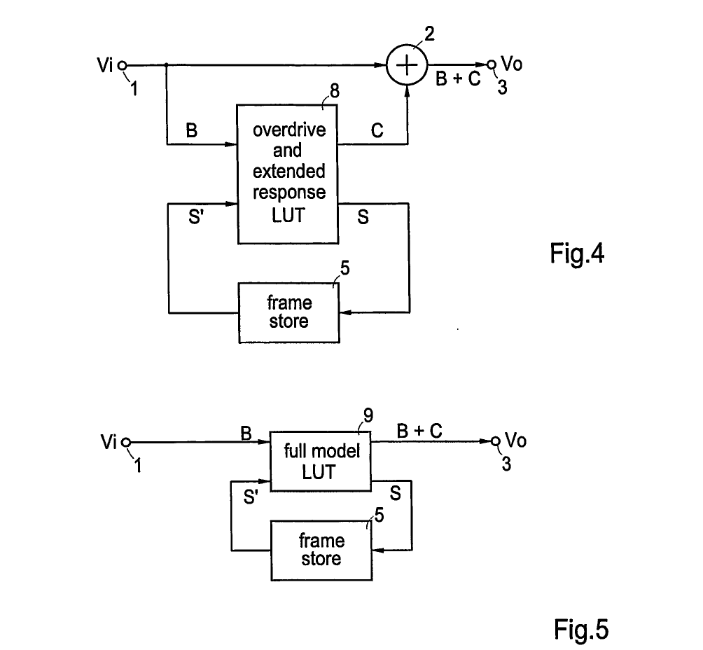

FIG. 4 shows a block circuit diagram of a third exemplary embodiment, and

FIG. 5 shows a block circuit diagram of a fourth exemplary embodiment.

The exemplary embodiment as well as parts thereof are in fact shown as block circuit diagrams. This does not mean, however, that the system according to the invention is limited to an implementation with the aid of individual circuits corresponding to the blocks. On the contrary, the system according to the invention can be implemented in a particularly advantageous way with the aid of large-scale integrated circuits. In this connection, a microcomputer comprising suitable memories may be used that, with suitable programming, performs the processing steps shown in the block circuit diagrams.

The known system in accordance with FIG. 1 has an input 1 for the incoming video signals Vi, which are fed via an adder 2 to an output 3 and are routed from there as corrected video signals Vo to a liquid-crystal display that is not shown. The video signals take the form of digital signals, a respective value being assigned to each pixel. These values are stored for each frame or picture in a store 5 and are simultaneously routed with the values A, read out of the frame store 5, of the preceding frame as input variables of a look-up table (overdrive LUT). For every pair A, B, the latter contains a correcting value C. The correcting values C taken from the look-up table 4 are chosen in such a way that as good a compensation as possible is made for the motion blur and are passed to the adder 2. As can be seen in FIG. 1, in addition to the current frame, only the preceding frame is taken into account in obtaining the correcting values.

In the system according to the invention shown in FIG. 2, the corrected values B+C of the video signals Vo are routed to a model 6 of the liquid-crystal display. The model represents the luminance response of the liquid-crystal display to the respective incoming video signal and is therefore denoted by “response model”. Its output variable S is stored in the frame store 5. The variable S′ read out of the frame store 5 of the preceding frame is used in addition to B+C as an input variable of the model 6. This results in a recursive structure so that a plurality of preceding frames are taken into account in deriving the correcting values C. Like the variable A already described in connection with FIG. 1, S′ is routed together with the values B to the look-up table 4.

In the second exemplary embodiment shown in FIG. 3, an expanded model 7 is used that contains the values B and S′ as an input variable. Compared with the exemplary embodiment shown in FIG. 2, the expanded model 7 takes account of the correcting value C since the latter depends only on the variables B and S′. Otherwise the exemplary embodiment shown in FIG. 3 is identical to that shown in FIG. 2.

Compared with the exemplary embodiment shown in FIG. 3, in the third exemplary embodiment shown in FIG. 4, the table for forming the correcting value C is combined with the model to form a common table 8. In the fourth exemplary embodiment show in FIG. 5, the adder 2 (FIG. 4) is finally accommodated in the table 9. As an example of the size of said table, it may be mentioned that for one channel in each case (for example R, G, B) the address area is 16 bits and the word size is likewise 16 bits. 8 bits are used for the output signal, while 8 bits are used to represent the variable S. The frame store 5 likewise has a size of 8 bits.

1. A system for driving inertia-prone picture-reproducing devices, in particular liquid-crystal displays, in which a correcting value depending on changes in the video signals from frame to frame is added to incoming video signals to compensate for the inertial effects and in which the corrected video signals are passed to the picture-reproducing device, characterized
in that, to form the correcting value, a model of the picture-reproducing device is provided that has a state variable as an output variable, the video signals as a first input variable and the state variable from a preceding frame as a second input variable, and
in that, furthermore, to derive the correcting value, a function having the incoming video signals and the state variable of the preceding frame serves as input variables and the corrected video signals as an output variable.

2. A system as claimed in claim 1, characterized in that the function is stored in a table.

3. A system as claimed in claim 1 characterized in that the corrected video signals are the first input variable of the model.

4. A system as claimed in claim 1 characterized in that the incoming video signals are the first input variable and in that the model includes a derivation of the correcting value.

5. A system as claimed in claim 1 characterized in that the model and the table for deriving the correcting value are combined in a common table.

6. A system as claimed in claim 5, characterized in that the common table furthermore contains an addition of the incoming video signals and the correcting value.

7. A system as claimed in claim 1, characterized in that interpolation nodes of the input and output variables are stored in the model and in that means are provided for interpolating between the interpolation nodes.
